(19) United States
(12) Patent Application Publication
(10) Pub. No.: US 2012/0058661 A1
(43) Pub. Date: Mar. 8, 2012

(54) CARD CONNECTOR HAVING PIVOTAL LOCKING MEMBER FOR PREVENTING CARD FROM WITHDRAWING THEREFROM

(75) Inventors: FENG-HUI WU, Shenzhen (CN); BIN-QUAN WANG, Shenzhen (CN)

(73) Assignee: HON HAI PRECISION INDUSTRY CO., LTD., New Taipei (TW)

(21) Appl. No.: 13/225,725

(22) Filed: Sep. 6, 2011

(30) Foreign Application Priority Data
Sep. 8, 2010 (CN) 201020523355.6

(51) Int. Cl. H01R 13/639

(52) U.S. Cl. 439/327

(57) ABSTRACT

A card connector includes an insulative housing, a number of contacts retained in the insulative housing, a metallic shell covering the insulative housing to jointly form a card receiving space, and a locking member pivotally mounted to the insulative housing. The locking member includes a card locking beam outside the card receiving space. The locking member is pivotable to an opening status where a card can be freely inserted into the card receiving space along a back-to-front direction, and the locking member is pivotable to a closed status where the card is restricted by the card locking beam in order to prevent the card from backwardly withdrawing from the card receiving space.

### BACKGROUND OF THE INVENTION

1. Field of the Invention

The present invention relates to a card connector, and more particularly to a card connector having an improved pivotal locking member for preventing an inserted card from withdrawing from the card connector.

2. Description of Related Art

Card connectors are key components widely used in handsets for receiving SIM cards. U.S. Pat. No. D569,346 S issued to Wu et al. on May 20, 2008 discloses such a card connector including an insulative housing, a plurality of contacts mounted on the insulative housing and a cover shielding the insulative housing to jointly form a card receiving space for accommodating a SIM card. When the SIM card is inserted into the card receiving space along a back-to-front direction, it can be well positioned in a vertical direction and the back-to-front direction. However, since no locking member is provided to limit a rear end of the SIM card, the SIM card may easily withdraw from the card receiving space along a front-to-back direction under some large external shocks such as when the handset drops to the ground.

Hence, a card connector having an improved locking member for preventing the card from withdrawing from the card receiving space is desired.

### BRIEF SUMMARY OF THE INVENTION

The present invention provides a card connector including an insulative housing, a plurality of contacts retained in the insulative housing, a metallic shell covering the insulative housing to jointly form a card receiving space, and a locking member pivotally mounted to the insulative housing. The locking member includes a card locking beam outside the card receiving space. The locking member is pivotable to an opening status where a card can be freely inserted into the card receiving space along a back-to-front direction, and the locking member is pivotable to a closed status where the card is restricted by the card locking beam in order to prevent the card from backwardly withdrawing from the card receiving space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a card connector in accordance with a first embodiment of the present invention;

FIG. 2 is an exploded view of the card connector as shown in FIG. 1, taken from another aspect;

FIG. 3 is another perspective view of the card connector as shown in FIG. 1, taken from another aspect;

FIG. 4 is a perspective view of the card connector under an opening status with a card inserted therein;

FIG. 5 is a perspective view of the card connector under a closed status for restricting the inserted card;

FIG. 6 is a perspective view of another card connector in accordance with a second embodiment of the present invention;

FIG. 7 is an exploded view of the card connector as shown in FIG. 6;

FIG. 8 is a perspective view of a locking member as shown in FIG. 7, taken from another aspect; and

FIG. 9 is a perspective view of the card connector under a closed status for restricting an inserted card.

### DETAILED DESCRIPTION OF THE PREFERRED EMBODIMENTS

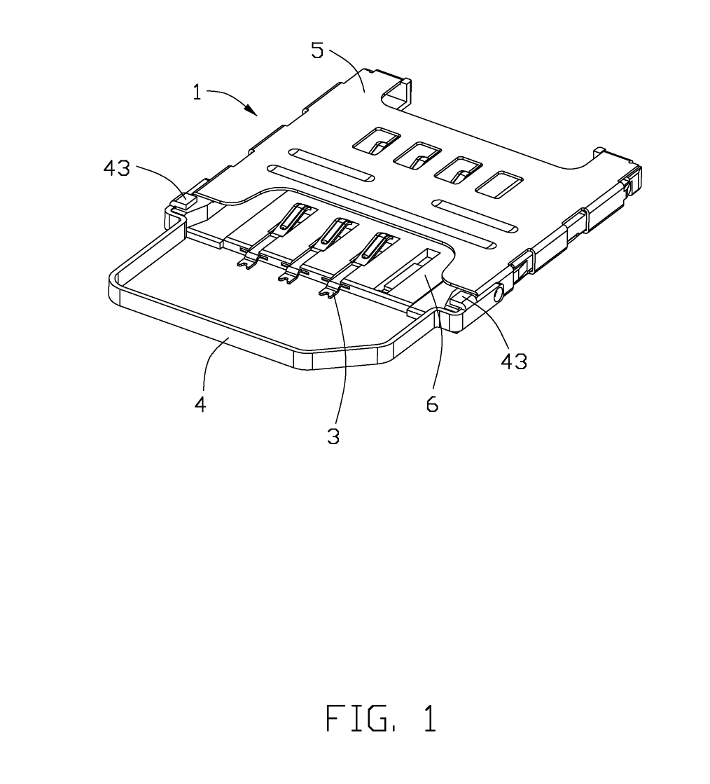

Reference will now be made to the drawing figures to describe the preferred embodiment of the present invention in detail. FIGS. 1 to 3 illustrate a card connector 1 in accordance with a first embodiment of the present invention. The card connector 1 includes an insulative housing 2, a plurality of contacts 3 retained in the insulative housing 2, a locking member 4 pivotally mounted to the rear side of the insulative housing 2 and a metallic shell 5 covering the insulative housing 2. The insulative housing 2 and the metallic shell 5 are jointly called a connector body in the following description. A card receiving space 6 is formed by the insulative housing 2 and the metallic shell 5 and is adapted for accommodating a card 7, such as a SIM card.

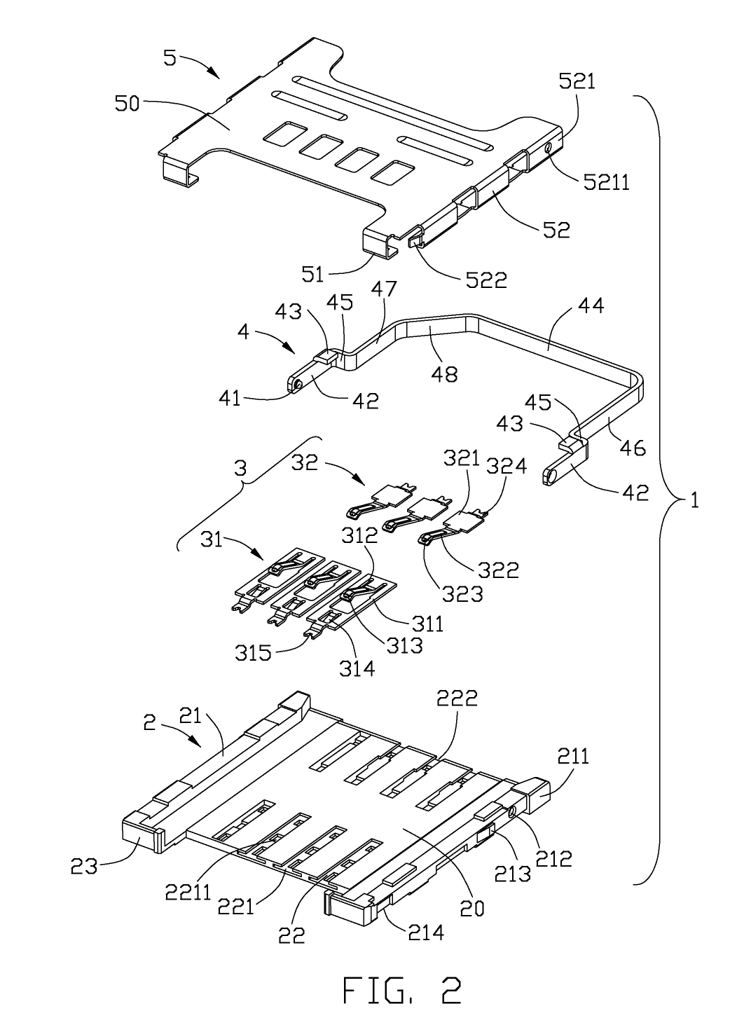

Referring to FIG. 2, the insulative housing 2 is rectangular shaped and includes a bottom wall 20 defining a plurality of contact receiving slots 22 and a pair of side walls 21 extending upwardly from opposite sides of the bottom wall 20. The contact receiving slots 22 include a plurality of first receiving slots 221 and a plurality of second receiving slots 222 in alignment with corresponding first receiving slots 221 along the back-to-front direction. A locking slot 2211 is further depressed at the middle of each first receiving slot 221. The outer side of each side wall 21 includes a mounting protrusion 211 adjacent to the rear side of the insulative housing 2, a pivot hole 212 at the front of the mounting protrusion 211, a tapering protrusion 213 at the front of the pivot hole 212 and a locking recess 214 adjacent to the front side of the insulative housing 2. Each side wall 21 further includes an engaging wall 23 extending sidewardly towards the card receiving space 6 and disposed at the front end of the insulative housing 2.

Referring to FIG. 2, the metallic shell 5 includes a top cover 50 above the bottom wall 20, a pair of side portions 52 bent downwardly from lateral sides of the top cover 50 and a pair of bending sections 51 extending downwardly from the front end of the top cover 50. The card receiving space 6 is formed between the bottom wall 20 and the top cover 50. The pair of bending sections 51 are attached to the engaging walls 23 of the insulative housing 2. The side portions 52 are attached to the side walls 21. Besides, each side portion 52 includes a locking portion 521 clipping the mounting protrusion 211 and a slant tab 522 abutting against the locking recess 214. As a result, the insulative housing 2 and the metallic shell 5 are stably combined together. The locking portion 521 defines a through hole 5211 in alignment with the pivot hole 212 along a transverse direction perpendicular to the back-to-front direction.

Referring to FIG. 2, the contacts 3 are received in the contact receiving slots 22 in two rows along the back-to-front direction. The contacts 3 are divided into two types one of which are designated first contacts 31 and the other of which are designated second contacts 32. Each first contact 31 includes a frame 311 received in the first receiving slot 221, a first contacting portion 313 protruding into the card receiving space 6 for mating with the card 7, a first connecting portion 312 connecting the frame 311 and the first contacting portion 313, a spring tab 314 engaging with the locking slot 2211, and a first soldering portion 315 extending from the frame 311. Each second contact 32 includes a flat base 321 received in the second receiving slot 222, a second contacting portion 323 protruding into the card receiving space 6 for mating with the card 7, a second connecting portion 322 connecting the base 321 and the second contacting portion 323, and a second soldering portion 324 extending from the base 321. The first and the second contacting portions 313, 323 extend along the back-to-front direction.

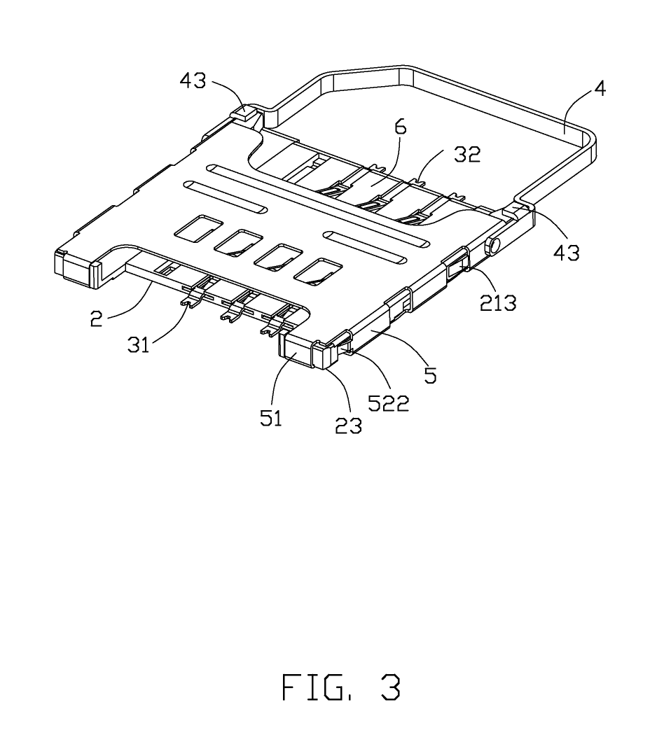

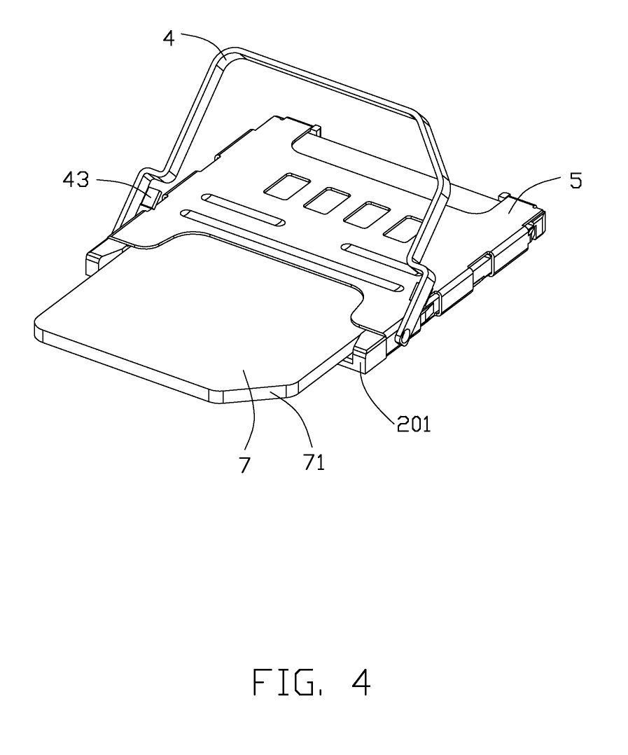

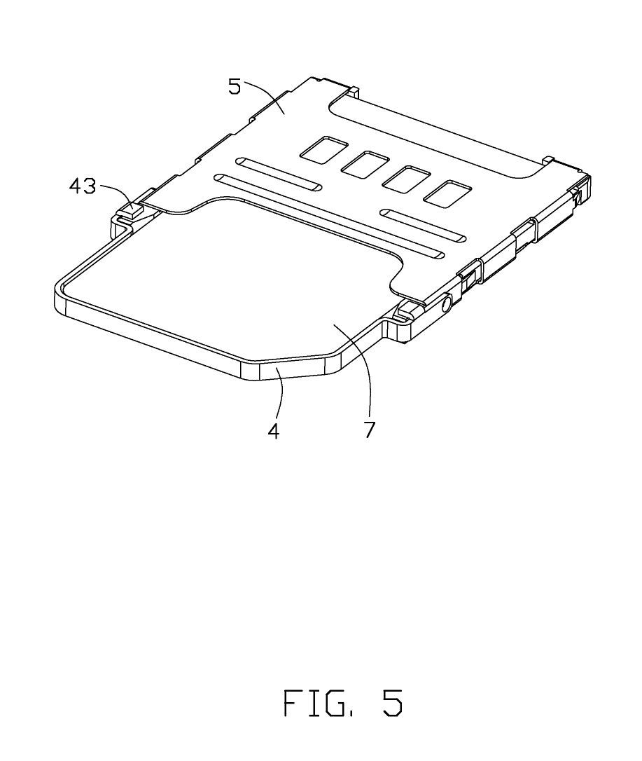

Referring to FIGS. 2 to 4, in accordance with the first embodiment of the present invention, the locking member 4 is substantially U-shaped and includes a pair of side arms 42 pivotally outwardly mounted to a pair of lateral sides of the connector body, a pair of blocks 43 horizontally bent from top edges of the side arms 42 towards the card receiving space 6, a pair of first extensions 45 extending inwardly from and perpendicular to the side arms 42, a second extension 46 extending backwardly from one of the first extensions 45 and a third extension 47 extending backwardly from the other of the first extensions 45, an inclined portion 48 extending from the third extension 47, and a card locking beam 44 bridging the third extension 47 and the inclined portion 48. The locking member 4 is pivotable in an upward direction to an opening status (as shown in FIG. 4) where the card 7 can be freely inserted into the card receiving space 6 along the back-to-front direction, and the locking member 4 is pivotable to a closed status (as shown in FIG. 5) where the card 7 is restricted by the card locking beam 44 in order to prevent the card 7 from backwardly withdrawing from the card receiving space 6. According to the illustrated embodiment of the present invention, each side arm 42 includes a pintle 41 located adjacent a distal end thereof. The pintle 41 is pivotally received in the through hole 5211 and the pivot hole 212. As shown in FIG. 3, the blocks 43 are abutting against a top side of the connector body so as to avoid over pivoting when the locking member 4 pivots from the opening status to the closed status. The pair of first extensions 45 are located onto an inserting face 201 of the insulative housing 2 as shown in FIGS. 4 and 5 for positioning the locking member 4 in the closed status. The second and the third extensions 46, 47 are parallel to the side arms 42 while the third extension 47 is shorter than the second extension 47. The inclined portion 48 is adapted for abutting against a slant corner 71 of the card 7 when the locking member 4 is under the closed status. According to the illustrated embodiment, the locking member 4 is mounted to the connector body from opposite lateral sides so that the locking member 4 can not fall off from the connector body.

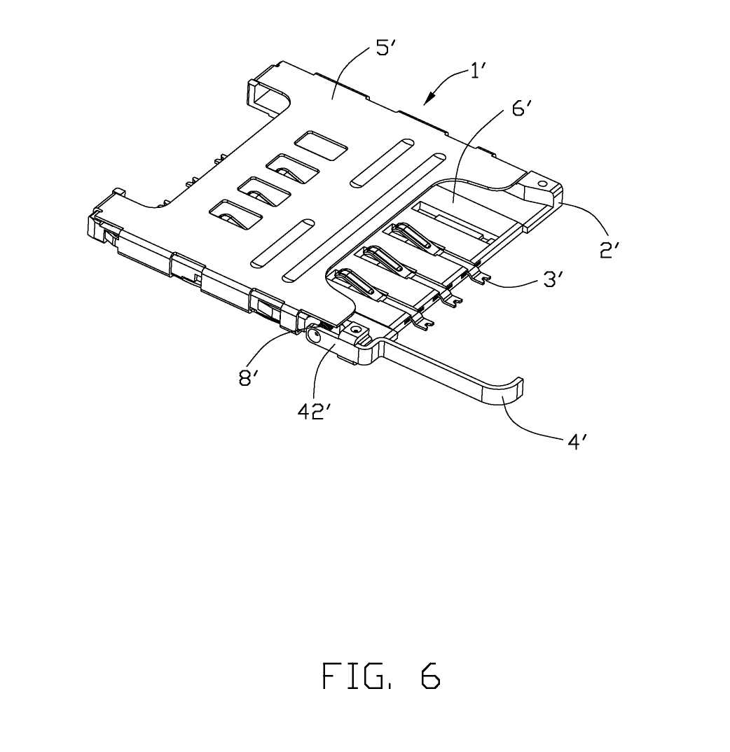

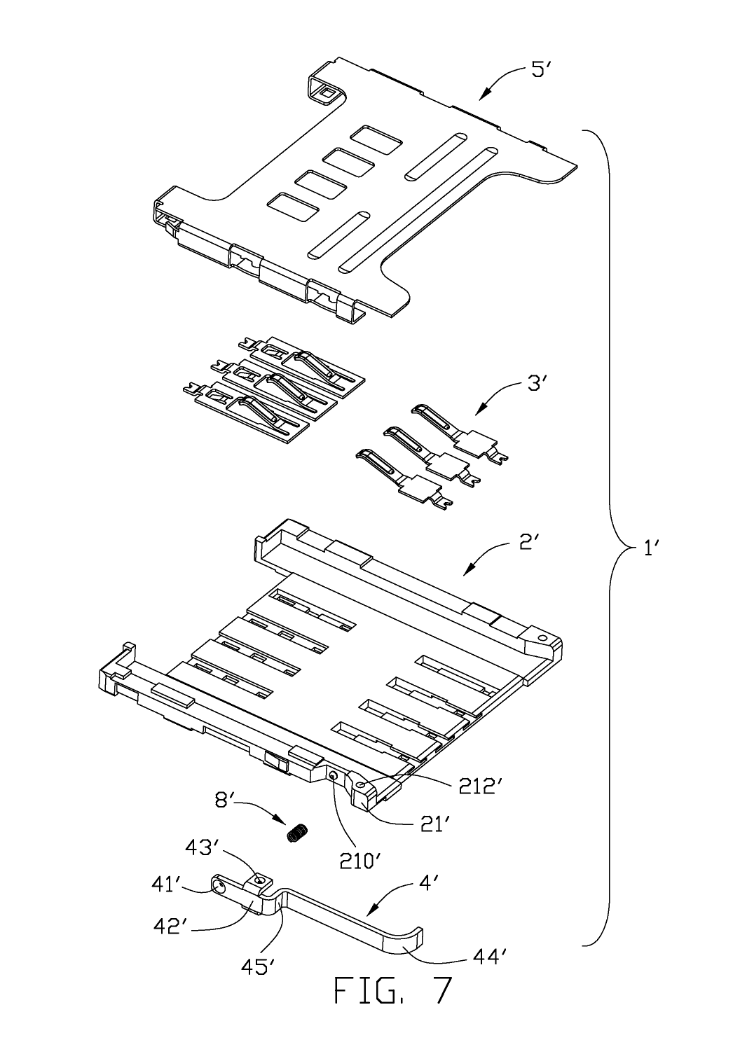

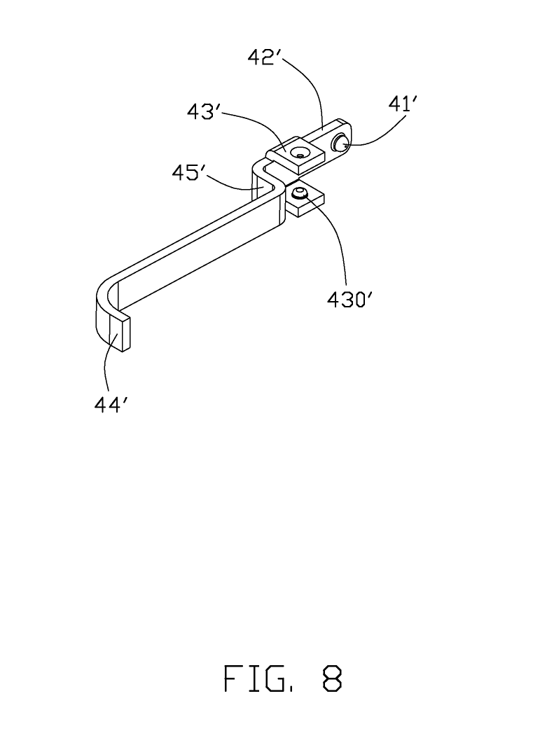

Referring to FIGS. 6 to 9, the present invention disclose another card connector 1′ according to an alternative embodiment. The card connector 1′ includes an insulative housing 2′, a plurality of contacts 3′ retained in the insulative housing 2′, a locking member 4′ pivotally mounted to the insulative housing 2′, a metallic shell 5′ covering the insulative housing 2′, and an elastic member 8′ sandwiched between the locking member 4′ and the insulative housing 2′. A card receiving space 6′ is formed by the insulative housing 2′ and the metallic shell 5′ and is adapted for accommodating a card 7′, such as a SIM card. The insulative housing 2′ and the metallic shell 5′ are jointly called a connector body as well. Since the card connector 1′ is similar to the card connector 1, only the locking member 4′ and corresponding structure on the insulative housing 2′ for mounting the locking member 4′ will be detailedly described.

The locking member 4′ is pivotally mounted to one side of the connector body and includes a side arm 42′, a pair of blocks 43′ horizontally bent from top and bottom edges of the side arm 42′ towards the card receiving space 6′, an extension 45′ bent inwardly from and perpendicular to the side arm 42′, and a L-shaped card locking beam 44′ extending backwardly from the extension 45′ and further beyond the card receiving space 6′.

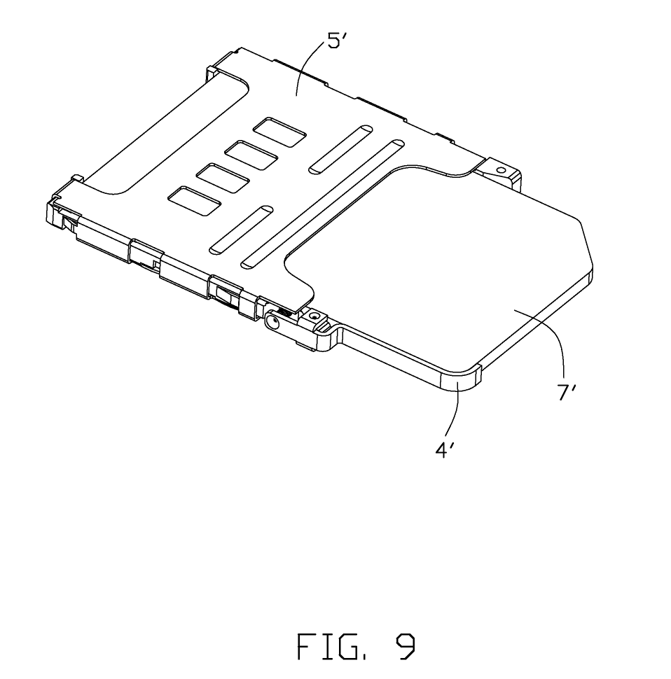

The side arm 42′ includes a first pin 41′ towards a side wall 21′ of the insulative housing 2′ and the side wall 21′ includes a second pin 210′ towards the first pin 41′. According to the illustrated embodiment of the present invention, the elastic member 8′ is a coiled spring which is positioned by the first and the second pins 41′ 210′ at two ends. The side wall 21′ further defines a pair of pivot holes 212′ on top and bottom surfaces thereof. The pair of blocks 43′ each include a pintle 430′ pivotally received in the corresponding pivot hole 212′. As a result, the locking member 4′ is pivotable along a horizontal/sideward direction to an opening status where the card 7′ can be freely inserted into the card receiving space 6′ along a back-to-front direction, and the locking member 4′ is pivoted by the elastic member 8′ to a closed status (as shown in FIG. 9) where the card 7′ is restricted by the card locking beam 44′ in order to prevent the card 7′ from backwardly withdrawing from the card receiving space 6′.

The pivot holes 212′ and the pintles 430′ are located between the elastic member 8′ and the card locking beam 44′ along the back-to-front direction. The elastic member 8′ is sandwiched between the side arm 42′ and the side wall 21′. Normally, the locking member 4′ is in the closed status under the action of the elastic member 8′. In use, an external force is applied to define over the elastic member 8′ and drive the locking member 4′ sidewardly and outwardly pivotal around the pintle 430′ to reach the opening status. Under such opening status, the elastic member 8′ is compressed. When the card 7′ is fully inserted into the card receiving space 6′, once withdrawing the external force, the elastic member is released so as to drive the locking member 4′ from the opening status to the closed status. Under the such closed status, a rear end of the card 7′ is restricted by the card locking beam 44′ so that the card 7′ is prevented from backwardly withdrawing from the card receiving space 6′.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A card connector comprising:
a connector body comprising an insulative housing and a metallic shell covering the insulative housing to jointly form a card receiving space;
a plurality of contacts retained in the insulative housing, each contact comprising a contacting portion protruding into the card receiving space; and
a locking member pivotally mounted to the connector body, the locking member comprising a card locking beam outside the card receiving space; wherein
the locking member is pivotable in an upward direction to an opening status where a card can be freely inserted into the card receiving space along a back-to-front direction, and the locking member is pivotable to a closed status where the card is restricted by the card locking beam in order to prevent the card from backwardly withdrawing from the card receiving space.

2. The card connector as claimed in claim 1, wherein the locking member comprises a block abutting against a top side of the connector body so as to avoid over pivoting when the locking member pivots from the opening status to the closed status.

3. The card connector as claimed in claim 1, wherein the locking member comprises a pair of side arms pivotally mounted to a pair of lateral sides of the connector body, each lateral side of the connector body defining a hole and each side arm comprising a pintle pivotally received in the hole.

4. The card connector as claimed in claim 3, wherein the insulative housing comprises a bottom wall with the contacts mounted thereon and a pair of side walls extending upwardly from opposite sides of the bottom wall, the metallic shell comprising a top cover above the bottom wall and a pair of side portions attached to the side walls, the hole comprising a first hole sidewardly extending through the side portion and a second hole defined sidewardly in the side wall.

5. The card connector as claimed in claim 3, wherein the locking member comprises a pair of first extensions extending inwardly from and perpendicular to the side arms, the insulative housing defining an inserting face through which the card receiving space extends, the pair of first extensions being located onto the inserting face when at the closed status.

6. The card connector as claimed in claim 5, wherein the locking member comprises a second extension extending backwardly from one of the first extensions and a third extension extending backwardly from the other of the first extensions, the second and the third extensions being parallel to the side arms while the third extension is shorter than the second extension.

7. The card connector as claimed in claim 6, wherein the locking member comprises an inclined portion extending from the third extension for abutting against a slant corner of the card when the locking member is under the closed status, the card locking beam bridging the third extension and the inclined portion.

8. The card connector as claimed in claim 3, wherein the locking member is substantially U-shaped and each pintle is located adjacent a distal end of the side arm.

9. A card connector comprising:
a connector body comprising an insulative housing and a metallic shell covering the insulative housing to jointly form a card receiving space;
a plurality of contacts each comprising a contacting portion protruding into the card receiving space;
a locking member pivotally mounted to the connector body, the locking member comprising a card locking beam extending backwardly beyond the card receiving space; and
an elastic member sandwiched between the locking member and the connector body; wherein
the locking member is outwardly and horizontally pivotable to reach an opening status where a card can be freely inserted into the card receiving space along a back-to-front direction, and the locking member is then pivoted by the elastic member to reach a closed status where the card is restricted by the card locking beam in order to prevent the card from backwardly withdrawing from the card receiving space.

10. The card connector as claimed in claim 9, wherein the elastic member is compressed when the locking member is under the opening status, and the elastic member is released so as to drive the locking member from the opening status to the closed status.

11. The card connector as claimed in claim 9, wherein the insulative housing comprises a bottom wall with the contacts mounted thereon and a side wall extending upwardly and laterally from the bottom wall, the locking member comprising a side arm parallel to the side wall, the elastic member being compressed between the side arm and the side wall.

12. The card connector as claimed in claim 11, wherein the elastic member is a coiled spring, the side arm comprising a first pin for positioning one end of the coiled spring and the side wall comprising a second pin for positioning the other end of the coiled spring.

13. The card connector as claimed in claim 11, wherein the side wall defines a first hole, the locking member comprising a first block extending towards the card receiving space from the side arm, the first block comprising a first pintle pivotally received in the first hole.

14. The card connector as claimed in claim 13, wherein the side wall defines a second hole opposite to the first hole, the locking member comprising a second block extending towards the card receiving space from the side arm, the second block being opposite to the first block with the side wall sandwiched therebetween, the second block comprising a second pintle pivotally received in the second hole.

15. The card connector as claimed in claim 14, wherein the first and the second blocks extend from upper and lower edges of the side arm, respectively, and the first and the second blocks are perpendicular to the side arm.

16. The card connector as claimed in claim 11, wherein the locking member comprises an extension sidewardly extending from and perpendicular to the side arm, the card locking beam being L-shaped and extending backwardly from the extension.

17. An electrical card connector for use with an electronic card, comprising:
a body unit defining a card receiving space communicating with an exterior in a first direction via an opening;
a plurality of contacts disposed in the body unit with contacting sections extending into the card receiving cavity in second direction perpendicular to said first direction;
a locking member constantly associated with and assembled to the body unit and moveable between a full open position for fully exposing the opening to the exterior, and a full locking position for locking a rear end of the corresponding electronic card when said electronic card is received in the card receiving space and the rear end extends through the opening into the exterior.

18. The electrical card connector as claimed in claim 17, wherein the locking member is pivotally moveable relative to the housing unit with a pivotal axis extending in a third direction perpendicular to both said first direction and said second direction.

19. The electrical card connector as claimed in claim 17, wherein said housing unit includes an insulative housing and a metallic shell.

20. The electrical card connector as claimed in claim 17, wherein said locking member defines a height similar to that of the housing unit when said locking member is located at the full locking position.
